(19) United States
(12) Patent Application Publication
(10) Pub. No.: US 2024/0267687 A1
(43) Pub. Date: Aug. 8, 2024

(54) METHOD AND SYSTEM FOR SOUND MONITORING OVER A NETWORK

(71) Applicant: Staton Techiya LLC, Delray Beach, FL (US)

(72) Inventors: Steven Wayne Goldstein, Delray Beach, FL (US); Marc Boillot, Plantation, FL (US); Jason Mclntosh, Sugar Hill, GA (US); John P. Keady, Fairfax Station, VA (US)

(73) Assignee: Staton Techiya LLC, Delray Beach, FL (US)

(21) Appl. No.: 18/425,025

(22) Filed: Jan. 29, 2024

Related U.S. Application Data
(63) Continuation of application No. 17/244,202, filed on Apr. 29, 2021.
Application No. 17/244,202 is a continuation of application No. 16/571,973, filed on Sep. 16, 2019, now Pat. No. 11,039,259.
Application No. 16/571,973 is a continuation of application No. 13/917,079, filed on Jun. 13, 2013, now Pat. No. 10,419,863.
Application No. 13/917,079 is a division of application No. 12/555,570, filed on Sep. 8, 2009, now Pat. No. 8,488,799.
(60) Provisional application No. 61/096,128, filed on Sep. 11, 2008.

(51) Int. Cl. H04R 29/00; G01H 3/14; G10L 19/00; H04M 1/72403; H04R 3/00

(52) U.S. Cl. CPC H04R 29/00; G01H 3/14; G10L 19/00; H04M 1/72403; H04M 2250/10; H04M 2250/12; H04R 3/00; H04R 2499/11

(57) ABSTRACT

Directed to a wearable device, that receives an acoustic signal from a microphone configured to measure an ambient environment; receives a sensor signal from a sensor; analyzing a sensor signal to detect a trigger event by comparing the sensor signal to a stored list that indicates which sensor signals indicate a trigger event; opening a communication channel with a remote server if a trigger event is detected; generating metadata including a time stamp; transmitting the metadata, the sensor signal and the acoustic signal to the server via the communication channel; and receiving, from the server an indication that the metadata, the sensor signal and acoustic signal has been received.

### BACKGROUND OF THE INVENTION

### 1. Field of the Invention

The present invention relates to a self-speech detection device, a voice input device, and a hearing aid having a function of distinguishing a voice uttered by a wearer from a voice coming from the outside world.

### 2. Description of the Related Art

Conventionally, a device using a bone conduction microphone has been put into practical use as a device for separating and identifying self-utterance, which is a voice uttered by a wearer, from an outside voice.

The bone conduction microphone detects the vibration of the skull caused by the wearer's voice through the attachment part that is in close contact with the wearer's ear canal. There is no sensitivity to external noise, which is air vibration, and the wearer's self-speech Only the sound can be picked up.

However, the bone conduction microphone is required to have close contact between the mounting portion and the ear canal in order to pick up the self-speech sound with high sensitivity. For this reason, it is necessary to match the shape of the wearing part with the shape of the ear canal of each wearer, and in the case of a cell type body in which the main body is integrated with the wearing part, it is necessary to replace the whole cell, so each wearer There was a problem that the fitting of was complicated.

An object of the present invention is to provide a self-speech detection device, a voice input device, and a hearing aid that can detect self-speech with a simpler configuration.

According to the invention of claim 1 of the present application, a mounting portion that is inserted into the ear canal of a wearer to insulate between the outside world and the ear canal, and a first microphone provided toward the outside world. A second microphone provided toward the ear canal; a delay unit that delays the signal of the first microphone for a predetermined time; a receiver that outputs the signal delayed by the delay unit into the ear canal; and a first microphone. And a signal processing unit that detects the self-utterance of the wearer based on the correlation between the signal waveform of (1) and the signal waveform of the second microphone.

In the invention of claim 2 of this application, in the invention of claim 1, the signal processing unit calculates a difference between the signal waveform of the first microphone and the signal waveform of the second microphone, and It is a processing unit that detects the wearer's self-utterance based on the correlation with the signal waveform of the microphone 1.

According to a third aspect of the present application, in the first aspect of the invention, the signal processing unit propagates the signal waveform of the first microphone delayed by the delay means including the ear canal from the receiver to the second microphone. The convolution calculation is performed by the transfer function of the road, the difference between the convolved signal waveform and the signal waveform of the second microphone is calculated, and the wearer's self is calculated based on the correlation between the difference signal waveform and the signal waveform of the first microphone. It is characterized in that it is a processing unit for detecting an utterance.

According to the invention of claim 4 of this application, in the invention of claim 3, a sound source for generating a test sound signal and inputting it to the delay means, a direct waveform of the test sound signal and a second microphone output from the receiver are used. It is characterized in that it further comprises means for calculating a transfer function of the propagation path based on the propagation waveform of the received test sound signal.

According to the invention of claim 5 of this application, a mounting portion that is inserted into the ear canal of the wearer to insulate between the outside world and the ear canal, the first microphone provided toward the outside world, and the inside of the ear canal are provided. A second microphone, a delay unit that delays the signal received by the first microphone for a predetermined time, a receiver that outputs the signal delayed by the delay unit into the ear canal, and a first microphone that is delayed by the delay unit. The signal waveform is convolved with the transfer function of the propagation path including the ear canal from the receiver to the second microphone, the difference signal waveform between this convolutional signal waveform and the signal waveform of the second microphone is extracted, and this difference signal waveform is And a signal processing unit for external output.

According to the invention of claim 6 of this application, in the invention of claim 5, the sound source for generating a test sound signal and inputting it to the delay means, the direct waveform of the test sound signal and the second microphone output from the receiver are used. It is characterized in that it further comprises means for calculating a transfer function of the propagation path based on the propagation waveform of the received test sound signal.

According to the invention of claim 7 of this application, a mounting portion that is inserted into the ear canal of the wearer to insulate between the outside world and the ear canal, a first microphone provided toward the outside world, and the inside of the ear canal are provided. The second microphone, the voice speed conversion means for extending the signal received by the first microphone on the time axis, the receiver for outputting the signal delayed by the delay means into the ear canal, and the voice speed conversion means. The signal waveform of the first microphone is convolved with the transfer function of the propagation path including the ear canal from the receiver to the second microphone, and the difference signal waveform between this convolutional signal waveform and the signal waveform of the second microphone and the first And a signal processing unit that detects the self-utterance of the wearer based on the correlation with the signal waveform of the microphone and prohibits the operation of the speech speed conversion means when the self-utterance is detected.

According to the invention of claim 8 of this application, in the invention of claim 7, a sound source for generating a test sound signal and inputting it to the delay means, a direct waveform of the test sound signal and a second microphone output from the receiver are used. It is characterized in that it further comprises means for calculating a transfer function of the propagation path based on the propagation waveform of the received test sound signal.

In the present invention, the second microphone receives not only the self-speech sound but also the external voice output from the receiver. On the other hand, the first microphone receives the foreign voice. By canceling the component of the external voice by correlating the signal waveform of the second microphone and the first signal waveform, only the self-speech sound component can be separated and extracted. The foreign voice received by the first microphone includes the self-speech sound uttered by the mouth, but the same processing may be performed.

Since the signal processing unit can be configured by a DSP or the like, the structure can be simplified even when performing complicated signal processing.

Therefore, according to the present invention, it is possible to separate and extract only the self-speech sound with a configuration of the mounting portion that is much simpler than that of the bone conduction microphone that only shields the outside world from the ear canal.

### BEST MODE FOR CARRYING OUT THE INVENTION

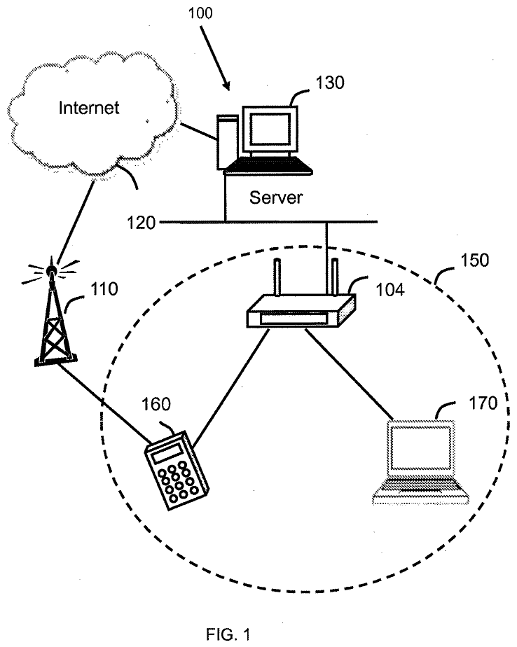

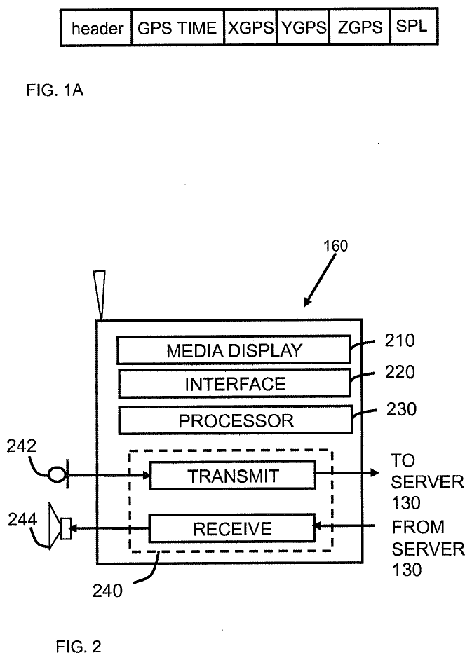

Embodiments of the present invention will be described with reference to the drawings. FIG. 1 is an external view of a self-speech detection device to which the present invention is applied. This self-speech detection device is used for a hearing aid and a voice input device. An earplug 2 which is a mounting portion to be inserted into the ear canal 4 is provided at the tip of the cell 1. The earplug 2 is made of an umbrella-shaped flexible resin, and is in close contact with the external auditory meatus wall 3 to block the external auditory meatus 4 from the outside world and prohibit the propagation of sound between them.

In the cell 1, a microphone 5 for detecting a sound coming from the outside world, a receiver 6 for outputting a sound to the ear canal 4, a microphone 7 for detecting a sound inside the ear canal 4, and a receiver 6, A pipe hole 8 that spatially connects with the microphone 7 is provided. The microphone 5, the receiver 6 and the microphone 7 are connected to the signal processing unit 9. The signal processing unit 9 is composed of an electronic circuit such as a DSP, analyzes and processes the audio signal input from the microphone 5 and the microphone 7, and outputs the processed audio signal from the receiver 6. Hereinafter, examples of various configurations of the signal processing unit 9 and their operations will be described.

FIG. 2 shows an example of a self-speech detection device in which the signal processing unit 9 is composed of a delay device 10, a correlation calculation device 11, and a speech determination device 12. In FIG. 2A, the external voice received by the microphone 5 is input to the delay device 10 and the correlation calculation device 11. The delay device 10 delays the input audio signal by a minute time t and outputs it to the receiver 6. The receiver 6 converts this voice signal into voice (air vibration) and emits it into the ear canal 4. The microphone 7 receives both the voice output by the receiver 6 and the voice of the wearer transmitted from the ear canal 4. The audio signal received by the microphone 7 is input to the correlation calculation device 11. The correlation calculation device 11 calculates a correlation value between the audio signal input from the microphone 5 and the audio signal input from the microphone 7.

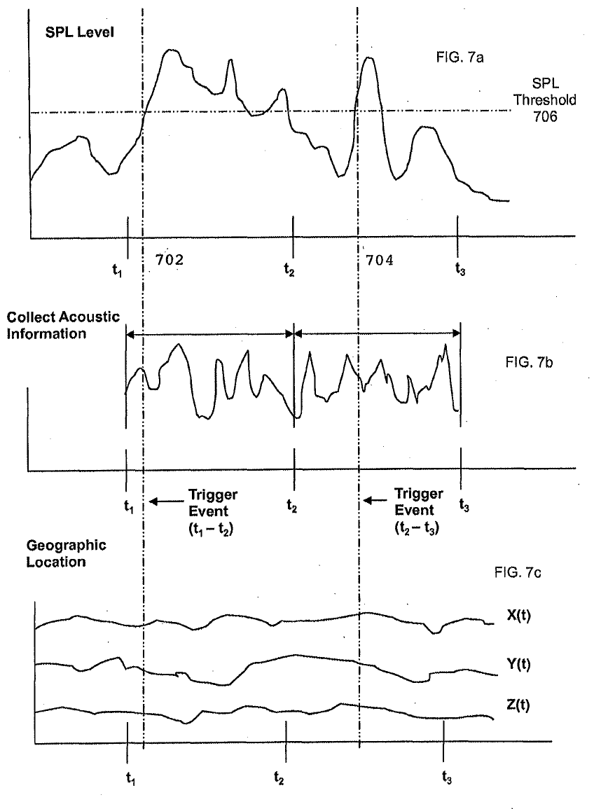

With reference to FIGS. 2B and 2C, the signal waveform and the correlation when the external voice arrives will be described. The time when the microphone 5 receives the foreign voice is 0 sec. The input point A waveform of the microphone 5 has a waveform as shown in the upper part of FIG. The delay device 10 delays this audio signal for tsec and outputs it to the receiver 6. The pointB waveform which is the waveform supplied to the receiver 6 is a waveform as shown in the middle part of FIG. 7B in which the waveform of pointA is delayed by tsec. The receiver 6 outputs the delayed audio signal to the ear canal 4. The sound output to the ear canal 4 is also received by the microphone 7. The pointC waveform which is the input of the microphone 7 has a waveform similar to the pointB waveform as shown in the lower part of FIG. The correlation calculation device 11 is a device that in time series examines how similar the point A waveform is to the reference waveform, using the point A waveform as the reference waveform, and outputs a correlation value proportional to the degree of the correlation. In the same figure (C), since there is no voice signal in the ear canal 4 at the time of 0 sec and the waveform of pointC is flat, the correlation value is 0, but the waveform of the voice delayed to pointC appears at time t. The correlation value at this time t becomes maximum.

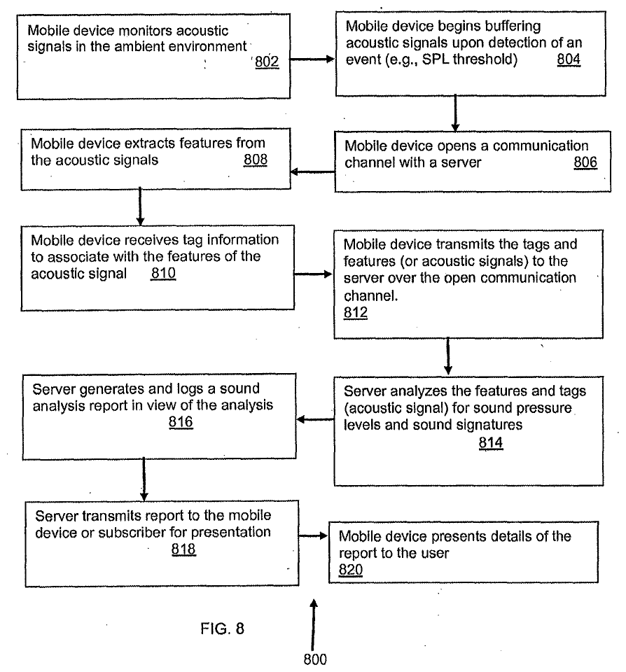

8B and 8C are diagrams in which the level of the input waveform is modeled, but actually the waveform as shown in FIG. 8 is shown. The same figure (A) shows the waveform of point A, and the same figure (B) shows the waveform of point C. And the same figure (C) is a correlation value. As described above, in the case of an analog waveform, the correlation value does not have a pulse shape, but the peak value also changes after tsec.

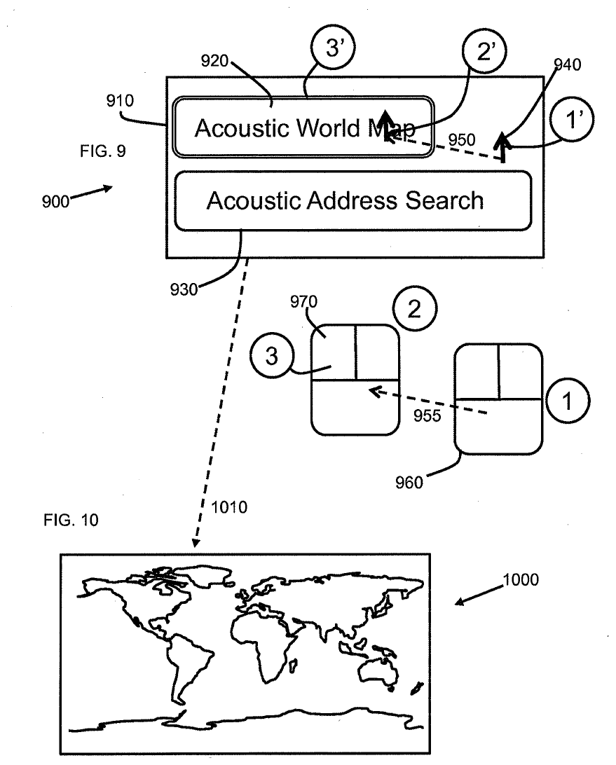

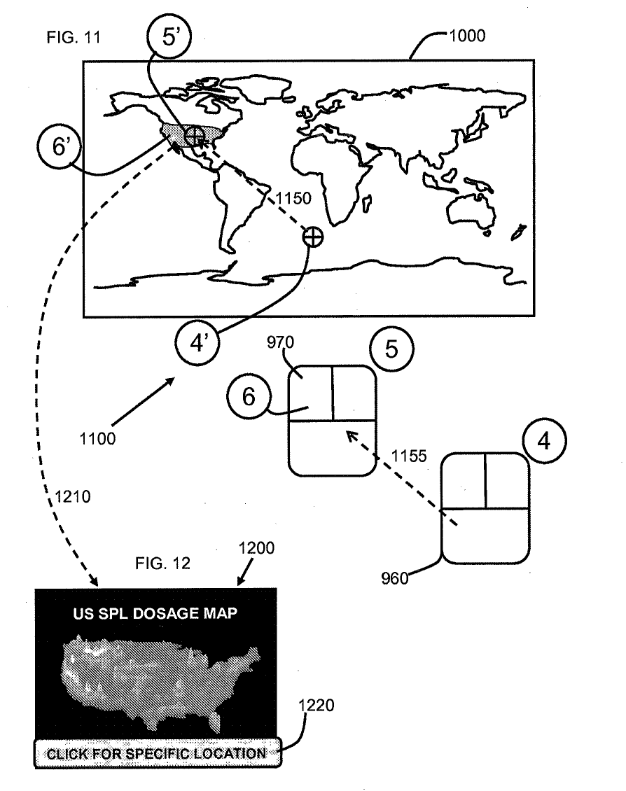

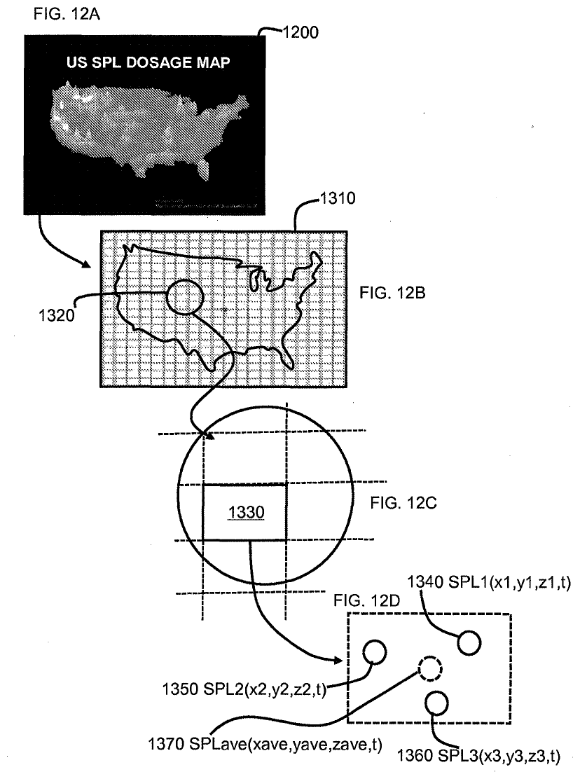

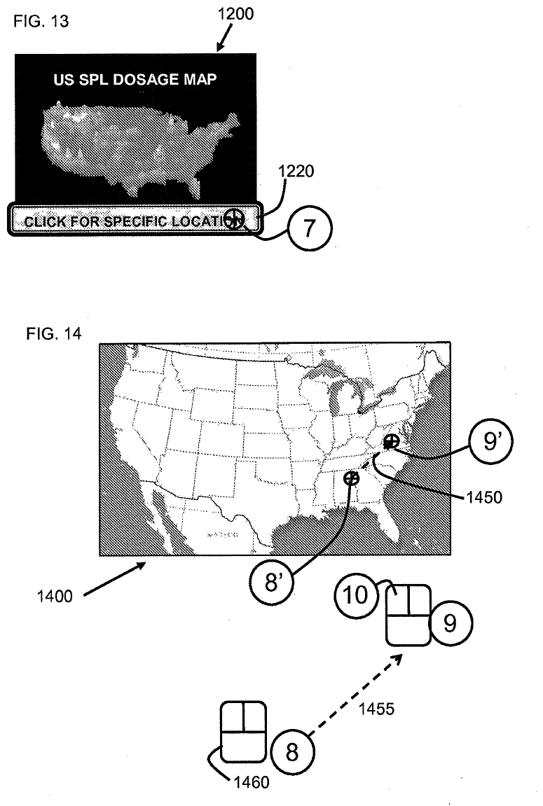

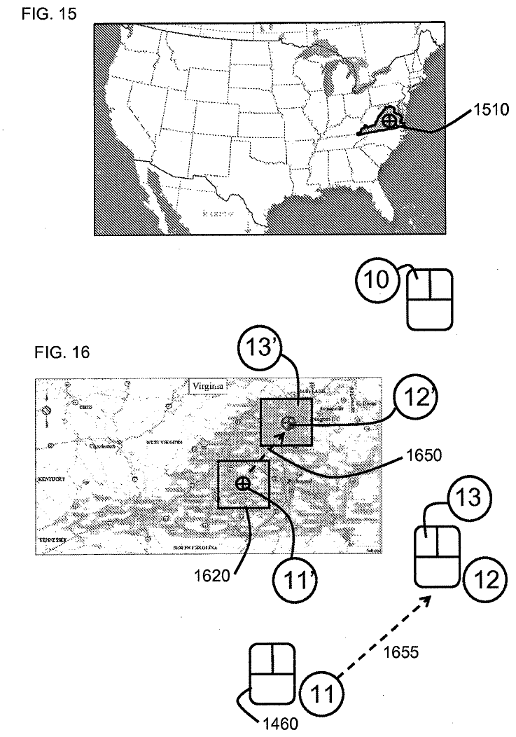

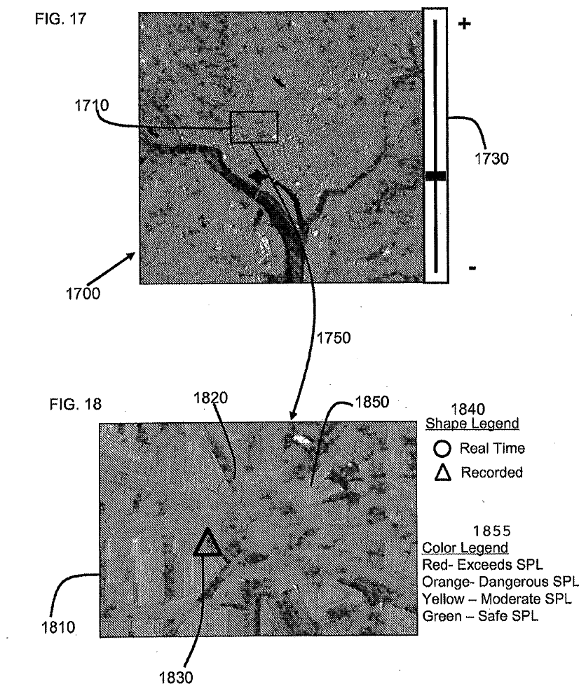

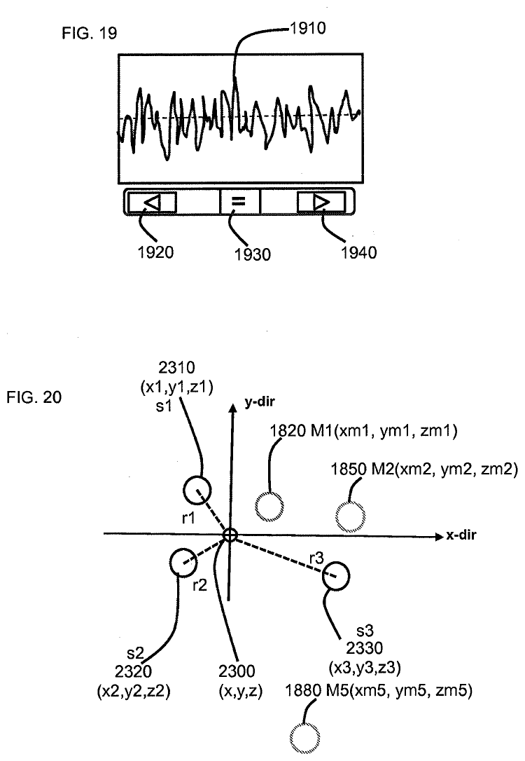

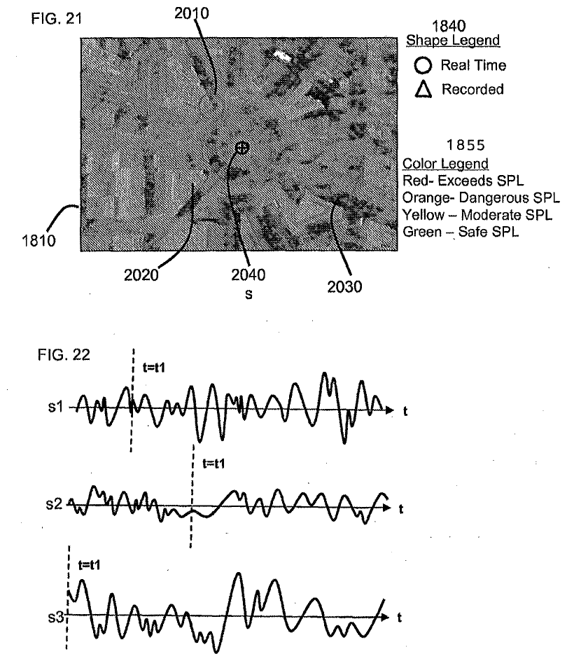

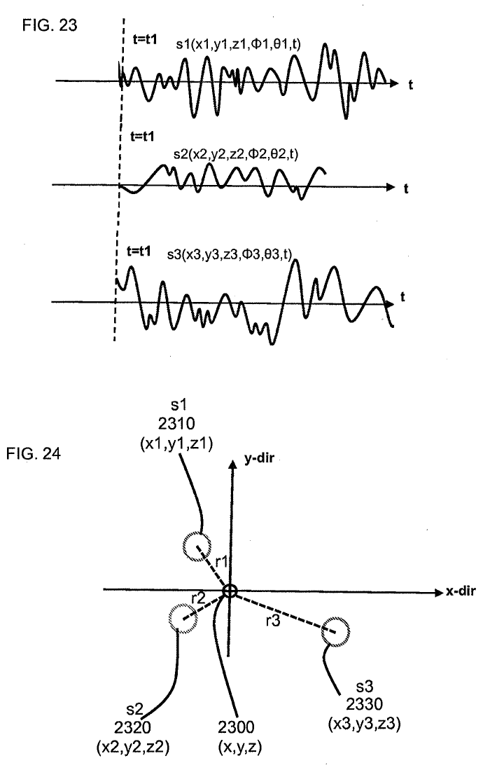

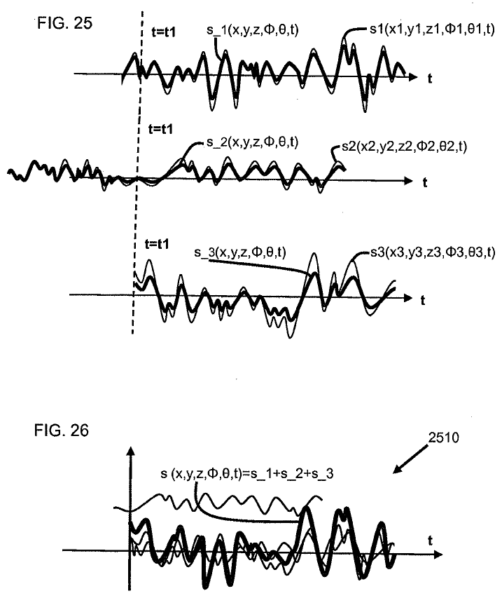

On the other hand, with reference to FIGS. 2D and 2E, the signal waveform and the correlation when self-speech is performed will be described. When the wearer utters, the sound signal is emitted from the mouth to the outside and also propagates into the ear canal 4 through the body propagation path. The sound emitted to the outside world is received by the microphone 5, and the sound propagated to the ear canal 4 is received by the microphone 7. Since the propagation distances of both are extremely short, they are received almost at the same time (0 sec). Therefore, at time 0 sec, a waveform as shown in the upper part of FIG. 9D appears at the point A which is the input of the microphone 5, and at the time 0 sec, a waveform similar to the point A waveform also appears at the time 0 sec. Further, the pointA waveform is delayed by the delay device 10 for tsec (pointB waveform) and then output from the receiver 6 to the ear canal 4, so that the microphone 7 also receives this sound, and the microphone 7 causes the wearer generated in the ear canal. Both the own voice and the delayed voice output from the receiver 6 are received, and the received pointC waveform is a synthesized waveform as shown in the lower part of FIG. At time 0 sec, the waveforms at point A and point C are almost the same, so the correlation calculation device 11 outputs a high correlation value at time 0 sec as shown in FIGS.

9D and 9E are diagrams in which the level of the input waveform is modeled, the waveforms shown in FIG. 9 are actually shown. The same figure (A) shows the waveform of point A, and the same figure (B) shows the waveform of point C. And the same figure (C) is a correlation value. As described above, in the case of an analog waveform, the correlation value does not have a pulse shape, but it also has a peak value at time 0 and is gradually attenuated.

Based on the difference in the correlation values described above, when the peak of the correlation value is output at 0 sec, the speech determination device 12 determines that the correlated waveform is due to self-speech, and the peak of the correlation value is output after tsec. Then, it is determined that the waveform is due to the foreign voice.

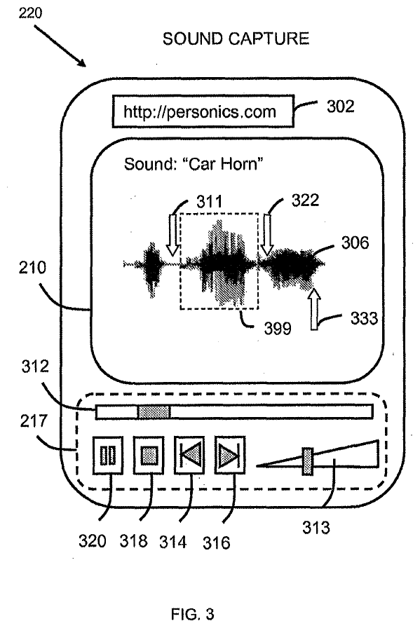

FIG. 3 shows an example of a self-speech detection device in which the signal processing unit 9 is composed of a delay device 10, a correlation calculation device 11, a speech determination device 12, and a difference processing device 13. In FIG. 3A, the external voice received by the microphone 5 is input to the delay device 10 and the correlation calculation device 11. The delay device 10 delays the input audio signal by tsec and outputs it to the receiver 6. The receiver 6 converts this voice signal into voice (air vibration) and emits it into the ear canal 4. The signal (pointB) delayed by the delay device 10 is also input to the difference processing device 13. On the other hand, the microphone 7 receives the sound generated in the external auditory meatus 4 and inputs it to the difference processing device 13. The microphone 7 receives both the voice output by the receiver 6 and the voice of the wearer transmitted from the ear canal 4. The difference processing unit 13 cancels the foreign voice component by subtracting the same voice signal waveform as that output from the delay unit 10 to the receiver 6 from the voice signal waveform input from the microphone 7. The speech signal waveform in which the foreign speech component is canceled is input to the correlation calculation device 11. The correlation calculation device 11 calculates a correlation value between the voice signal input from the microphone 5 and the voice signal input from the difference processing device 13.

With reference to FIGS. 3B and 3C, the signal waveform and the correlation when the foreign voice arrives will be described. The time when the microphone 5 receives the foreign voice is set to 0 sec. Point A, which is the input to the microphone 5, has a waveform as shown in the first stage of FIG. The delay device 10 delays this audio signal for tsec and outputs it to the receiver 6. Since the pointB waveform supplied to the receiver 6 is the pointA waveform delayed by tsec, it has a waveform as shown in the second stage of FIG. The receiver 6 outputs the delayed audio signal to the ear canal 4. The sound output to the ear canal 4 is also received by the microphone 7. The pointC waveform, which is the input signal waveform of the microphone 7, has a waveform similar to the pointB waveform as shown in the third stage of FIG. The difference processing device 13 subtracts the pointC waveform, which is the audio signal waveform input from the microphone 7, from the pointB waveform, which is the audio signal waveform input from the delay device 10. In the case of only foreign voice, since there is no internally generated voice signal, the pointB waveform and the pointC waveform almost match, and the pointD waveform which is the output of the difference processing device 13 is as shown in the fourth stage of FIG. 1t becomes a flat signal of almost 0 level. The correlation calculation device 11 is a device that in time series examines how similar the point A waveform is to the reference waveform, using the point A waveform as the reference waveform, and outputs a correlation value proportional to the degree of the correlation. In this example, since the waveform of pointD is almost flat, there is almost no correlation with the reference waveform of pointA, and a large correlation value is not output. The utterance determination device 12 determines that there is no self-utterance because a large correlation value is not input.

On the other hand, a signal waveform and a correlation when a self-speech is performed will be described with reference to FIGS. When the wearer utters, the voice signal is emitted from the mouth to the outside world and also propagates into the ear canal 4 through the body propagation path. The sound emitted to the outside world is received by the microphone 5, and the sound transmitted to the external auditory meatus 4 is received by the microphone 7. Since the propagation distances of both are extremely short, they are received almost at the same time (0 sec). Therefore, the waveform of the point A appears at the microphone 5 at the time 0 sec, and the waveform similar to the point A also appears at the microphone 7 at the time 0 sec. Further, the waveform of the point A is delayed by the delay device 10 for tsec and then emitted from the receiver 6 to the ear canal 4, so that the microphone 7 also receives this voice. That is, the microphone 7 receives both the voice of the wearer himself/herself generated in the ear canal and the delayed voice emitted from the receiver 6, and the synthesized waveform thereof is as shown in the third row of FIG. It becomes the waveform of pointC. The difference processing device 13 subtracts the pointC waveform which is the voice signal waveform input from the microphone 7 and the pointB waveform which is the voice signal waveform input from the delay device 10. Since the pointC waveform is a composite signal of the internally transmitted waveform and the voice waveform output from the receiver 6, when the pointB waveform is subtracted from this, the waveform component of the external voice output from the receiver 6 is canceled, and) As shown in the fourth row, the waveform becomes similar to pointA. The correlation calculation device 11 is a device that in time series examines how similar the point A waveform is to the reference waveform, using the point A waveform as the reference waveform, and outputs a correlation value proportional to the degree of the correlation. In this example, since the waveform of pointD almost coincides with the waveform of pointA, a large correlation value is output at the timing of 0 sec. The utterance determination device 12 determines that there is a self-utterance started at the timing of 0 sec due to the input of the large correlation value. As described above, in the example of FIG. 3, since the extra signal is eliminated by the difference processing device 13, the correlation value is improved and the error determination can be expected to be reduced.

The examples of FIGS. 2 and 3 have been described for the case where the signal path is ideal and the frequency characteristics and phase characteristics of the path have almost no effect, but consider the case where the propagation characteristics of the signal path affect the waveform of the audio signal. An example is shown in FIG.

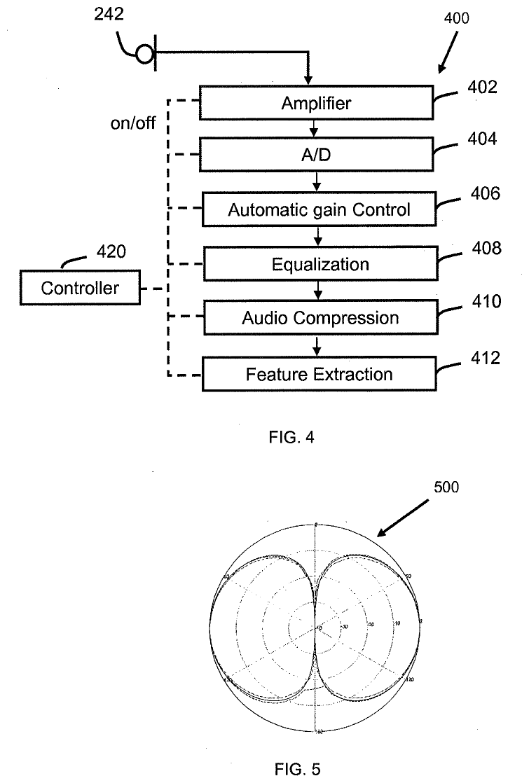

In the example of FIG. 4, the signal processing unit 9 includes a delay device 10, a correlation calculation device 11, a speech determination device 12, a difference processing device 13, and a transfer function correction device 14.

In FIG. 4A, the external voice received by the microphone 5 is input to the delay device 10 and the correlation calculation device 11. The delay device 10 delays the input audio signal by tsec and outputs it to the receiver 6. The receiver 6 converts this voice signal into voice (air vibration) and emits it into the ear canal 4. The pointB waveform delayed by the delay device 10 is also input to the transfer function correction device 14. The transfer function correction device 14 filters the input signal and inputs it to the difference processing device 13. This filter is a filter that simulates the impulse response of the ear canal 4 when the device is inserted into the ear canal 4, so that the signal passing through this filter has the same waveform as the signal propagating in the ear canal 4. Is designed. That is, by passing through this filter, the transfer function of the propagation path is convoluted with respect to the signal waveform.

On the other hand, the microphone 7 receives the sound generated in the external auditory meatus 4 and inputs it to the difference processing device 13. The microphone 7 receives both the voice output by the receiver 6 and the voice of the wearer transmitted from the ear canal 4. The difference processing device 13 subtracts the audio signal waveform input from the transfer function correction device 14 from the audio signal waveform input from the microphone 7 to cancel this component. The audio signal waveform from which the output of the receiver 6 has been canceled is input to the correlation calculation device 11. The correlation calculation device 11 calculates a correlation value between the voice signal input from the microphone 5 and the voice signal input from the difference processing device 13.

With reference to FIG. 4(B), the signal waveform and the correlation when the foreign voice arrives will be described. The time when the microphone 5 receives the foreign voice is set to 0 sec. Point A, which is the input to the microphone 5, has a waveform as shown in the first stage of FIG. The delay device 10 delays this audio signal for tsec and outputs it to the receiver 6. The pointB, which is the waveform applied to the receiver 6, has a waveform as shown in the second stage of FIG. 7B, which is obtained by delaying the waveform of the pointA by tsec. The receiver 6 outputs the delayed audio signal to the ear canal 4. The sound output to the ear canal 4 is also received by the microphone 7. The point C, which is the input of the microphone 7, has almost the same timing as the point B, but the delay component is superimposed due to the propagation through the external auditory meatus 4, and the waveform is as shown in the third stage of FIG. Since the waveform obtained by correcting the pointB waveform output from the delay device 10 by the transfer function correction device 14 is input to the difference processing device 13, this waveform is subtracted from the point C which is the audio signal waveform input from the microphone 7 . . . . Since the waveform of pointB corrected by the transfer function correction device 14 is almost the same as the waveform of pointC, these waveforms almost match and the pointE waveform which is the output of the difference processing device 13 is shown in FIG. As shown in the fifth stage, the signal becomes a flat signal of almost 0 level. The correlation calculating device 11 is a device for checking in time series how similar the point A waveform is to the reference waveform with the point A waveform as the reference waveform, and outputs a correlation value proportional to the degree of the correlation. In this example, since the waveform of point E is almost flat, there is almost no correlation with the reference waveform of point A, and a large correlation value is not output. The utterance determination device 12 determines that there is no self-utterance because a large correlation value is not input.

On the other hand, with reference to FIG. 4C, the signal waveform and the correlation when self-utterance is performed will be described. When the wearer utters, the sound signal is emitted from the mouth to the outside and also propagates into the ear canal 4 through the body propagation path. The sound emitted to the outside world is received by the microphone 5, and the sound transmitted to the external auditory meatus 4 is received by the microphone 7. Since the propagation distances of both are extremely short, they are received almost at the same time (0 sec). Therefore, the waveform of the point A appears at the microphone 5 at the time 0 sec, and the waveform similar to the point A waveform also appears at the microphone 7 at the time 0 sec. Further, the waveform of the point A is delayed by the delay device 10 for tsec and then emitted from the receiver 6 to the ear canal 4, so that the microphone 7 also receives this voice. The signal emitted from the receiver 6 and received by the microphone 7 is a signal that propagates through the external auditory meatus 4 and is input, so that the reverberation sound component of the external auditory meatus 4 is superimposed. Therefore, the synthesized waveform of the direct sound of the self-utterance received by the microphone 7 and the sound output from the receiver 6 becomes the pointC waveform shown in the third stage of FIG. The sound signal emitted from the receiver 6 and propagated through the external auditory meatus 4 has a gradual rise and fall of the waveform because the reverberation component is superimposed due to the propagation characteristics of the external auditory meatus 4 as described above. Since the waveform output from the transfer function correction device 14 also passes through a filter having the transfer characteristic of the external auditory meatus 4 as a filter coefficient, similar reverberation components are superposed, and this signal is input from the input signal of the microphone 7. By subtracting, only the self-speech sound can be separated (pointE waveform).

The correlation calculation device 11 is a device that in time series examines how similar the point A waveform is to the reference waveform, using the point A waveform as the reference waveform, and outputs a correlation value proportional to the degree of the correlation. In this example, since the waveform of pointD almost coincides with the waveform of pointA, a large correlation value is output at the timing of 0 sec. The utterance determination device 12 determines that there is a self utterance started at the timing of 0 sec due to the input of the large correlation value.

In FIG. 4A, if the output of the difference processing device 13 is taken out as it is, it can function as a self-speech detecting microphone.

Although the transfer function correction device 14 is inserted between the delay device 10 and the difference processing device 13 in the device of FIG. 4A, it may be placed between the microphone 7 and the difference processing device 13 as shown in FIG. Can also In this case, since the transfer function is also convoluted with the self-speech voice generated in the ear canal, the transfer function correction device that restores the waveform of the self-speech sound after the difference processing is the difference processing device 14 and the correlation calculation device 11. To be installed between and.

Note that, in the examples of FIGS. 3 and 4, the correlation calculation device 11 may be a simple comparison calculation device because it only compares two audio signal waveforms that occur simultaneously. Further, the delay device 10 of FIGS. 4 and 5 may be a signal processing device that digitally delays a signal.

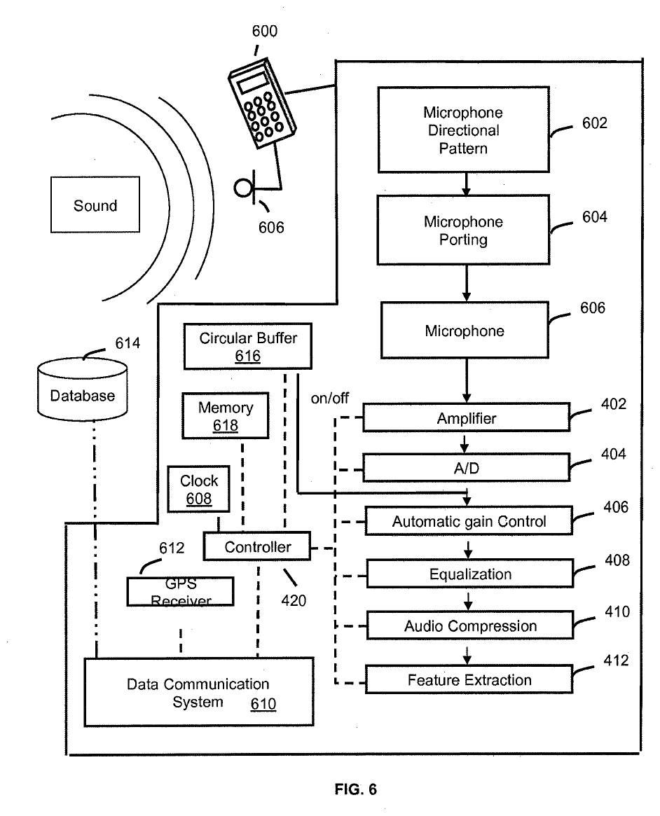

FIG. 6 is a diagram showing an embodiment in which the present invention is applied to a voice input/output device of a communication terminal. A control device 30 for controlling this device controls the device in a transfer function calculation mode and a normal operation mode. The indicator device 33 includes a switch for the wearer to instruct the controller 30 to turn on/off the device.

6, as a system of the microphone 5-delay device 10-receiver 6 of FIGS. 1 and 4A, a microphone 5 (this device also has the same external appearance as that of FIG. 1; the same applies hereinafter), an amplifier 36, An A/D converter 37, a delay device 38, a D/A converter 39, an amplifier 40 and a receiver 6 are provided. A microphone 7-amplifier 41 and an A/D converter 42 are provided as a system of the microphone 7 in FIGS. 1 and 4A. Further, the functions of the transfer function correction device 14, the difference processing device 13, and the comparison operation device 11 of FIG. 4A are implemented by software by the control device 30 and the operation processing device 35. Further, this apparatus has a built-in sound source 34 for generating a test sound signal in a transfer function calculation mode for calculating the transfer function of the ear canal 4. The audio signal formed by the sound source 34 is input to the A/D converter 37 as a test sound signal instead of being input to the microphone 5.

When the instruction device 33 gives an instruction to turn on, the control unit 30 first sets the transfer function mode, the control device 30 turns on the sound source 34, and instructs the arithmetic processing device 35 to perform a transfer function arithmetic operation. The test sound signal formed by the sound source 34 may be white noise or pink noise, but may be another signal, for example, a waveform of an impulse or a low-frequency signal having a fixed frequency. The test sound signal output from the sound source 34 is emitted into the external auditory meatus 4 via the A/D converter 37, the delay device 38, the D/A converter 39, the amplifier 40, and the receiver 6. The test sound emitted into the ear canal 4 is detected by the microphone 7 provided toward the ear canal 4. The output of the microphone 7 is input to the arithmetic processing unit 35 via the amplifier 41 and the A/D converter 42. The arithmetic processing unit 35 may be configured by a DSP or the like. On the other hand, the arithmetic processing unit 35 is also supplied with a signal obtained by converting the test sound signal formed by the sound source 34 into a digital signal from the A/D converter 37. The arithmetic processing unit 35 compares the pointA signal (the signal input from the A/D converter 37) and the pointB signal (the signal input from the A/D converter 42) as the transfer function operation and compares these signals. A correction coefficient is calculated according to the difference between There are various methods for obtaining the correction coefficient. Then, a function G(k) such that

G(k)·A(k)−B(k)=E(k) Once obtained, the function G(k) is in a relatively stable state unless the device is removed from the ear canal. You just need to calculate. When the calculation is completed, the processing unit 35 goes into a standby state. When the control device 30 detects that the arithmetic processing device 35 is in the standby state, the control device 30 stops the sound source 34 and instructs the arithmetic processing device 35 to perform a signal processing operation to switch to the normal operation mode.

In the normal operation mode, when an external sound is input from the microphone 5, it passes through the amplifier 36, the A/D converter 37, the delay device 38, the D/A converter 39, and the amplifier 40, and after tsec from the receiver 6 to the ear canal 4. Is output. The external sound output to the external auditory meatus 4 is received by the microphone 7 provided toward the external auditory meatus 4, and is input to the arithmetic processing unit 35 via the amplifier 41 and the A/D converter 42. The arithmetic processing unit 35 in which the signal processing operation is set, after convolving the transfer function G(k) obtained above into the pointA signal input from the A/D converter 37, that is, the direct foreign voice signal, The difference calculation processing is performed with the pointB signal, that is, the signal including the external audio signal transmitted through the external auditory meatus 4. By this processing, the foreign voice component is deleted from the pointB signal and only the self-speech voice is extracted. If the extracted self-speech voice is connected to the voice input terminal of the communication device, only a voice signal with little noise can be picked up and sent to the other party even in a place where environmental noise is large.

In the above example, the output of the A/D converter 37 (pointA signal) is input to the arithmetic processing device 35 as the reference signal, but the output of the delay device 38 may be input.

FIG. 7 is a diagram showing an embodiment in which the present invention is applied to a hearing aid having a speech speed conversion function. The control device 50 for controlling this device controls the device in the transfer function calculation mode and the normal operation mode. The indicator device 53 includes a switch for the wearer to instruct the controller 50 to turn on/off the device.

In FIG. 7, as a system of the microphone 5-delay device 10-receiver 6 of FIGS. 1 and 4A, a microphone 5 (this device also has the same external appearance as that of FIG. 1; the same applies hereinafter), an amplifier 56, An A/D converter 57, a speech speed conversion/gain control device 58, a D/A converter 59, an amplifier 60 and a receiver 6 are provided. A microphone 7-amplifier 61 and an A/D converter 62 are provided as a system of the microphone 7 in FIGS. 1 and 4(A). Further, the functions of the transfer function correction device 14, the difference processing device 13, and the comparison operation device 11 of FIG. 4A are realized by software by the control device 50 and the operation processing device 55. Further, this apparatus has a built-in sound source 54 for generating a test sound signal in a transfer function calculation mode for calculating the transfer function of the ear canal 4. The audio signal formed by the sound source 54 is output by the receiver 9 provided outside and is received by the microphone 5.

When the instruction device 53 gives an instruction to turn on, the control unit 50 first sets the transfer function mode, the control device 50 turns on the sound source 54, and instructs the arithmetic processing device 55 to perform a transfer function arithmetic operation. The test sound signal formed by the sound source 54 may be white noise or pink noise, but may be formed of another signal, for example, an impulse or a waveform of a low frequency signal having a fixed frequency. The test sound signal output from the sound source 54 is output from the receiver 9 and received by the microphone 5 and converted into an electric signal, and then the A/D converter 57, the speech speed conversion/gain control device 58, and the D/A conversion. It is emitted into the ear canal 4 through the container 59, the amplifier 60, and the receiver 6. The test sound emitted into the ear canal 4 is detected by the microphone 7 provided toward the ear canal 4. The output of the microphone 7 is input to the arithmetic processing unit 55 via the amplifier 61 and the A/D converter 62. The arithmetic processing unit 55 may be composed of a DSP or the like. On the other hand, the arithmetic processing unit 55 is also supplied with the voice source 54 formed by the voice speed conversion/gain control unit 58 and the voice speed converted from the test sound signal output from the receiver 9. The arithmetic processing unit 35 compares the point C signal (the signal input from the speech speed conversion/gain control unit 58) and the point B signal (the signal input from the A/D converter 62) as the transfer function arithmetic operation, and The correction coefficient is calculated according to the difference in the signal of. There are various methods for obtaining the correction coefficient, but for example, the point A signal is A(k), the point B signal is B(k), and the error E(k) between A(k) and B(k) is zero as shown in the following equation. Then, a function G(k) such that

G(k)·A(k)−B(k)=E(k) Once obtained, the function G(k) is in a relatively stable state unless the device is removed from the ear canal. You just need to calculate. When the calculation is completed, the calculation processing device 55 enters the standby state. When the control device 50 detects that the arithmetic processing device 55 is in the standby state, the control device 50 stops the sound source 54 and instructs the arithmetic processing device 55 to perform a signal processing operation to switch to the normal operation mode.

In the normal operation mode, when an external sound is input from the microphone 5, it passes through the amplifier 56, the A/D converter 57, the speech speed conversion/gain control device 58, the D/A converter 59, the amplifier 60, and the receiver after tsec. 6 is output to the ear canal 4. The external sound output to the external auditory meatus 4 is received by the microphone 7 provided toward the external auditory meatus 4, and is input to the arithmetic processing unit 55 via the amplifier 61 and the A/D converter 62. The arithmetic processing unit 55 to which the signal processing operation is set convolves the transfer function G(k) obtained above with the pointC signal input from the speech speed conversion/gain control unit 58, that is, the direct foreign voice signal. After that, a difference calculation process is performed with the pointB signal, that is, the signal including the external audio signal transmitted through the external auditory meatus 4. By this processing, the foreign voice component is deleted from the pointB signal and only the self-speech voice component is extracted. When the microphone 5 receives only the foreign voice, the self-speech voice component is 0, but when self-speaking, the component of that level is extracted. When the arithmetic processing device 55 extracts the self-speech voice component, the control device 50 prohibits the voice speed conversion/gain control device 58 from performing the voice speed conversion and controls the gain to be small. As a result, the speech speed conversion for the self-speech is prohibited, and the self-speech is smoothly performed.

In the above example, the output of the A/D converter 57 (pointA signal) may be input to the arithmetic processing device 55 as a reference signal.

As a result, the speech speed conversion is desired to be applied to the foreign voice, but not to the vocalized voice. When a person speaks, since the person controls the utterance while listening to his/her own voice, there arises a problem that the person cannot speak well if the uttered speech is delayed. Therefore, it is necessary to detect the utterance section and not apply the speech speed conversion process to the self-utterance. In addition, since the self-speech voice sounds louder than the foreign voice, it is necessary to control the gain so as to have an appropriate volume.

In this way, since it is possible to separate the self-speech and the external sound with a simple configuration, when this is used in a speech speed conversion hearing aid, it is used in the same cell regardless of the shape of the ear canal of the wearer. be able to.

According to the present invention, since the external voice signal is canceled from the input signal of the second microphone provided toward the ear canal to extract only the self-speech sound, the structure is complicated. It is possible to extract only the self-speech voice from which the external voice such as environmental noise is removed without using a bone conduction microphone whose setting is delicate for each wearer.

Also, if this is used as a hearing aid, the speech speed conversion can be prohibited only in the section of the self-speech voice, and a hearing aid that can easily speak can be configured.

What is claimed is:

1. A wearable device, comprising:
a microphone;
a sensor;
a memory that stores instructions; and
a processor that executes the instructions to perform operations, the operations comprising:
receiving an acoustic signal from the microphone configured to measure an ambient environment;
receiving a sensor signal from the sensor;
analyzing a sensor signal to detect a trigger event by comparing the sensor signal to a stored list that indicates which sensor signals indicate a trigger event;
opening a communication channel with a remote server if a trigger event is detected;
generating metadata including a time stamp;
transmitting the metadata, the sensor signal and the acoustic signal to the server via the communication channel; and
receiving, from the server an indication that the metadata, the sensor signal and acoustic signal has been received.

2. The device of claim 1, wherein the operations further comprise transmitting the metadata, the sensor signal, and the acoustic signal as a package to the server over the communication channel.

3. The device of claim 1, wherein the operations further comprise transmitting the metadata, the sensor signal, and the acoustic signal separately to the server via separate communications over the communication channel.

4. The device of claim 1, wherein the operations further comprise:
analyzing the acoustic signal to detect a sonic signature.

5. The device of claim 4, wherein the operations further comprise:
analyzing the sonic signature to detect a trigger event by comparing the sonic signature to a stored list that indicates which sonic signature indicates a trigger event.

6. The device of claim 1, wherein the operations further comprise:
buffering the acoustic signal upon detection of the trigger event.

7. The device of claim 1, wherein the operations further comprise:
receiving location data.

8. The device of claim 2, wherein location data is included in the package.

9. The device of claim 1, wherein the sensor measures an acceleration.

10. The device of claim 1, wherein the operations further comprise presenting a threat level associated with the trigger event.

11. A method, comprising:
receiving an acoustic signal from a microphone configured to measure an ambient environment;
receiving a sensor signal from a sensor;
analyzing a sensor signal to detect a trigger event by comparing the sensor signal to a stored list that indicates which sensor signals indicate a trigger event;
opening a communication channel with a remote server if a trigger event is detected;
generating metadata including a time stamp;
transmitting the metadata, the sensor signal and the acoustic signal to the server via the communication channel; and
receiving, from the server an indication that the metadata, the sensor signal and acoustic signal has been received.

12. The method of claim 11, wherein the method further comprises:
transmitting the metadata, the sensor signal, and the acoustic signal as a package to the server over the communication channel.

13. The method of claim 11, wherein the method further comprises:
transmitting the metadata, the sensor signal, and the acoustic signal separately to the server via separate communications over the communication channel.

14. The method of claim 11, wherein the method further comprises:
analyzing the acoustic signal to detect a sonic signature.

15. The method of claim 14, wherein the method further comprises:
analyzing the sonic signature to detect a trigger event by comparing the sonic signature to a stored list that indicates which sonic signature indicates a trigger event.

16. The method of claim 11, wherein the method further comprises:
buffering the acoustic signal upon detection of the trigger event.

17. The method of claim 11, wherein the method further comprises:
receiving location data.

18. The method of claim 12, wherein location data is included in the package.

19. The method of claim 11, wherein the sensor measures an acceleration.

20. The method of claim 11, wherein the method further comprises:
displaying a threat level associated with the trigger event.
